(19) United States
(12) Patent Application Publication
(10) Pub. No.: US 2026/0037778 A1
(43) Pub. Date: Feb. 5, 2026

(54) SYSTEM AND METHOD FOR GENERATING REPLACEMENT CONTENT

(71) Applicant: Wolters Kluwer DXG U.S., Inc, Riverwoods, IL (US)

(72) Inventors: Michael Forgit, Auburn, MA (US); Brian Ashley Packard, North Chelmsford, MA (US); David Mark Kerwin, Sandown, NH (US); Manish Vazirani, Holliston, MA (US)

(21) Appl. No.: 18/793,043

(22) Filed: Aug. 2, 2024

(51) Int. Cl. G06N 3/0455

(52) U.S. Cl. CPC G06N 3/0455

(57) ABSTRACT

System and methods for generating replacement content are disclosed. Replacement text is generated by replacing at least one respective character portion of a first instance of an initial keyword with a first set of replacement characters to generate a first replacement keyword. At least one respective character portion of a second instance of the initial keyword is replaced with a second set of replacement characters to generate a second replacement keyword. Machine encodings of the first replacement keyword, second replacement keyword, and the initial keyword are distinct. In response to receiving a request for initial text, instructions are generated to display, via a human readable user interface, replacement text including the first replacement keyword and the second replacement keyword.

### TECHNICAL FIELD

This application relates generally to generating replacement content and, more particularly, to systems and methods for generating replacement content to obstruct training of content using machine learning.

### BACKGROUND

Machine learning models have become very prevalent in many applications. These models are continuously being trained based on content available, such as content available on the Internet. In some instances, these models, or mechanisms for training the models, parse and extract information from content on the Internet without obtaining express permission from the content creators. Although unauthorized use of materials may implicate one or more content violations, e.g., violations of copyright, terms of use, contractual rights, etc., the use of specific content for training of machine learning models can be difficult to detect.

In order to avoid such copying, it is currently required to monitor output of machine learning models to attempt to identify outputs generated as a result of training on unauthorized material. However, such methods are difficult to implement, as the output of machine learning models, such as large-language models (LLMs), typically does not directly recreate training data. Further, even where unauthorized copying is detected, it may be difficult or even impossible to remove influences of that content from a model that has been previously trained on the unauthorized content.

### SUMMARY

The embodiments described herein are directed to a system having a data store storing initial text including a plurality of instances of at least one initial keyword, a computing device may include at least one processor in communication with the data store, the computing device being configured to identify, for the at least one initial keyword, at least two sets of replacement characters corresponding to at least one respective character portion of the initial keyword, where each of the at least two sets of replacement characters have a visually similar appearance to the at least one respective character portion of the initial keyword when rendered on a display, generate replacement text by for a first instance of the initial keyword in the initial text, replacing the at least one respective character portion of the initial keyword with a first set of replacement characters to generate a first replacement keyword, where a machine encoding of the initial keyword and a machine encoding of the first replacement keyword are distinct, for a second instance of the initial keyword in the initial text, replacing at least one respective character portion of the initial keyword with a second set of replacement characters to generate a second replacement keyword, where a machine encoding of the second replacement keyword is distinct from the machine encoding of the initial keyword and the machine encoding of the first replacement keyword, and generate instructions to display, via a human readable user interface, replacement text including the first replacement keyword and the second replacement keyword, where each of first replacement keyword, the second replacement keyword, and the initial keyword have a visually similar appearance when rendered on the human readable user interface.

In some embodiments, the replacement text is displayed in response to a user request to view the initial text on the human readable user interface. The replacement text includes a set of n replacement keywords, and where each replacement keyword in the set of replacement keywords has a different machine encoding, and where the machine encoding of each of the replacement keywords is distinct from the machine encoding of the initial keyword.

In some embodiments, the first replacement keyword includes a zero-width element. The first replacement keyword may include a zero-width text string. The machine representation may include a machine generated token.

In some embodiments, the computing device is further configured to parse the initial text when prompted by a user initiated function when the human readable user interface is displaying the replacement text. The replacement text includes a distinct replacement keyword associated with each instance of the initial keyword.

In some embodiments, the computing device is further configured to receive a request from a computing device, the request having a request type, transmit the replacement text to computing device based on the request type meeting replacement text criteria, and transmit the initial text to computing device based on the request type meeting initial text criteria. The replacement text includes one or more homoglyphs.

Embodiments of the present invention are directed to method including storing, in a data store, initial text including a plurality of instances of at least one an initial keyword, identifying, for the at least one initial keyword, at least two sets of replacement characters corresponding to at least one respective character portion of the initial keyword, where each of the at least two sets of replacement characters have a visually similar appearance to the at least one respective character portion of the initial keyword when rendered on a display, generating replacement text by: for a first instance of the initial keyword in the initial text, replacing the at least one respective character portion of the initial keyword with a first set of replacement characters to generate a first replacement keyword, where a machine encoding of the initial keyword and a machine encoding of the first replacement keyword are distinct, for a second instance of the initial keyword in the initial text, replacing at least one respective character portion of the initial keyword with a second set of replacement characters to generate a second replacement keyword, where a machine encoding of the second replacement keyword is distinct from the machine encoding of the initial keyword and the machine encoding of the first replacement keyword, and generating instructions to display, via a human readable user interface, replacement text including the first replacement keyword and the second replacement keyword, where each of first replacement keyword, the second replacement keyword, and the initial keyword have a visually similar appearance when rendered on the human readable user interface.

In some embodiments, the replacement text is displayed in response to a user's request to view the initial text on the human readable user interface, the replacement text being visually similar to the initial text when rendered on the human readable user interface. Each of the replacement text includes a plurality of replacement keywords, each being different from the initial keyword when parsed by a machine.

In some embodiments, the replacement text includes a replacement keyword including zero-width text. The replacement text may include a replacement keyword having a text string embedded within. In some embodiments, tokenization of the replacement text generates a different series of tokens compared to tokenization of the initial text.

In some embodiments, the method of includes parsing the initial text when prompted by a search function initiated by a user interacting with the human readable user interface when the human readable user interface is displaying the replacement text. The replacement text includes a plurality of replacement keywords associated with each instance of the initial keyword and tokenization of the plurality of replacement keywords results in each instance of the plurality of replacement keywords having a different token.

In some embodiments, the method of includes receiving a request from a computing device, the request having a request type, and transmitting the replacement text to computing device based on the request type meeting replacement text criteria or transmit the initial text to computing device based on the request type meeting initial text criteria.

Embodiments of the present invention are directed to a non-transitory computer readable medium having instructions stored thereon, where the instructions, when executed by at least one processor, cause at least one device to perform operations include storing, in a data store, initial text including a plurality of instances of at least one an initial keyword, identifying, for the at least one initial keyword, at least two sets of replacement characters corresponding to at least one respective character portion of the initial keyword, where each of the at least two sets of replacement characters have a visually similar appearance to the at least one respective character portion of the initial keyword when rendered on a display, generating replacement text by for a first instance of the initial keyword in the initial text, replacing the at least one respective character portion of the initial keyword with a first set of replacement characters to generate a first replacement keyword, where a machine encoding of the initial keyword and a machine encoding of the first replacement keyword are distinct, for a second instance of the initial keyword in the initial text, replacing at least one respective character portion of the initial keyword with a second set of replacement characters to generate a second replacement keyword, where a machine encoding of the second replacement keyword is distinct from the machine encoding of the initial keyword and the machine encoding of the first replacement keyword, and generating instructions to display, via a human readable user interface, replacement text including the first replacement keyword and the second replacement keyword, where each of first replacement keyword, the second replacement keyword, and the initial keyword have a visually similar appearance when rendered on the human readable user interface . . . .

Embodiments of the present invention are directed to a system including: a data store storing initial text and replacement text, where the replacement text is visually similar to the initial text when rendered on a human readable user interface and different than the initial text when parsed by a machine, a computing device may include at least one processor in communication with the data store, the computing device being configured to receive a request with a request type from a user device to view the initial text on a display screen of the user device, determine whether the request type meets replacement text criteria or initial text criteria, if the request type meets initial text criteria, render the initial text on the display screen of the user device, and if the request type meets replacement text criteria, render the replacement text on the display screen of the user device . . . .

In some embodiments, the replacement text includes a plurality of replacement keywords and the initial text includes a plurality of instances of an initial keyword, each of the plurality of replacement keywords being different from the initial keyword when parsed by a machine.

In some embodiments, one or more of the plurality of replacement keywords includes one or more of zero-width text and a text string embedded within. One or more of the plurality of replacement keywords includes a homoglyph of one or more character portions of the initial keyword.

In some embodiments, the initial text includes a plurality of instances of an initial keyword, each instance of the initial keyword including an initial character . . . .

In some embodiments, the computing device is further configured to: generate a plurality of replacement characters, replace the initial character of each instance of the initial keyword with a different replacement character of the plurality of replacement characters to generate a plurality of replacement keywords, each replacement keyword of the plurality of keywords being different from one another and visually similar to the initial keyword when rendered on a human readable user interface, and replace each instance of the initial keyword of the initial text with a different replacement keyword of the plurality of the replacement keywords to generate the replacement text. The replacement text criteria includes request types from one or more of a web scraping tool, a web browser, a machine, or a model training application. The initial text criteria includes request types from a mobile electronic reader.

In some embodiments, the computing device is further configured to parse the initial text when prompted by a search function initiated by a user interacting with the display screen of the user device when the display screen is displaying the replacement text.

In some embodiments, tokenization of the replacement text generates a different series of tokens compared to tokenization of the initial text.

Embodiments of the present invention are directed to a method including storing, in a data store, initial text and replacement text, where the replacement text is visually similar to the initial text when rendered on a human readable user interface and different than the initial text when parsed by a machine, receiving a request with a request type from a user device to view the initial text on a display screen of the user device, determining whether the request type meets replacement text criteria or initial text criteria, if the request type meets initial text criteria, rendering the initial text on the display screen of the user device, and if the request type meets replacement text criteria, rendering the replacement text on the display screen of the user device . . . .

In some embodiments, the replacement text includes a plurality of replacement keywords and the initial text includes a plurality of instances of an initial keyword, each of the plurality of replacement keywords being different from the initial keyword when parsed by a machine. One or more of the plurality of replacement keywords includes one or more of zero-width text, a text string embedded within, and a homoglyph.

In some embodiments, the initial text includes a plurality of instances of an initial keyword, each instance of the initial keyword including an initial character.

In some embodiments, the method includes generating a plurality of replacement characters, replacing the initial character of each instance of the initial keyword with a different replacement character of the plurality of replacement characters to generate a plurality of replacement keywords, each replacement keyword of the plurality of keywords being different from one another and visually similar to the initial keyword when rendered on a human readable user interface, and replacing each instance of the initial keyword of the initial text with a different replacement keyword of the plurality of the replacement keywords to generate the replacement text.

In some embodiments, the replacement text criteria includes request types originating from one or more of a web scraping tool, a web browser, a machine, or a model training application. The initial text criteria includes request types originating from a mobile electronic reader.

In some embodiments, the method includes parsing the initial text when prompted by a search function initiated by a user interacting with the display screen of the user device when the display screen is displaying the replacement text. Tokenization of the replacement text generates a different series of tokens compared to tokenization of the initial text.

Embodiments of the present invention are directed to a non-transitory computer readable medium having instructions stored thereon, where the instructions, when executed by at least one processor, cause at least one device to perform operations may include storing, in a data store, initial text and replacement text, where the replacement text is visually similar to the initial text when rendered on a human readable user interface and different than the initial text when parsed by a machine, receiving a request with a request type from a user device to view the initial text on a display screen of the user device, determining whether the request type meets replacement text criteria or initial text criteria if the request type meets initial text criteria, rendering the initial text on the display screen of the user device, and if the request type meets replacement text criteria, rendering the replacement text on the display screen of the user device.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 is a network environment configured to generate replacement text, in accordance with some embodiments;

FIG. 2A is an illustration of initial text, in accordance with some embodiments;

FIG. 2B is an illustration of the initial text of FIG. 2A with initial keywords being identified, in accordance with some embodiments;

FIG. 2C is an illustration of character portions of the initial keyword of FIG. 2B being identified and replaced with replacement characters to generate replacement keywords, in accordance with some embodiments;

FIG. 2D is an illustration of replacement text including the replacement keywords of FIG. 2C, in accordance with some embodiments;

FIG. 3 is a block diagram of a system for generating replacement content, in accordance with some embodiments;

FIG. 4 is a flow diagram of a system for generating replacement content, in accordance with some embodiments;

FIG. 5 is a flow diagram of a system for generating replacement content, in accordance with some embodiments; and

FIG. 6 is a block diagram of a replacement content generator, in accordance with some embodiments.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages or alternative embodiments herein can be assigned to the other claimed objects and vice versa. In other words, claims for the systems can be improved with features described or claimed in the context of the methods. In this case, the functional features of the method are embodied by objective units of the systems.

The present disclosure provides systems and methods for generating replacement content elements for textual content data. In some embodiments, the systems and methods utilize a replacement content generator to replace one or more initial content elements with replacement content elements. The initial content elements may form initial keywords that are disposed throughout an initial text. The replacement content elements may for replacement keywords, which are included in a replacement text. The replacement content elements may obstruct parsing of the textual content, making it difficult or impossible to train models through parsing of the textual content. For example, one or more machine learning models may be trained by parsing and extracting keywords from content available on the Internet and provided to the model. In some embodiments, a model parses content and extracts keywords, for example, through tokenization of individual content elements. The model may then make associations between the keywords directly and/or between the keywords and other labels or tags. For example, the model may identify keywords and associations between the keywords and other words in the content to learn patterns and relationships. In order to prevent parsing of content by the model, content may be “poisoned” with replacement content elements, preventing the model from consistently identifying keywords and/or making associations between the keywords and/or other labels or tags. For example, in some embodiments, a replacement content element is based off of an initial content element (e.g., non-replacement content element) and is visually identical to the initial content element when rendered on a display screen for a user to view but generates a different output as the initial content element when parsed by a machine.

In some embodiments, the initial content elements are text elements generated by a content creator. The text may include a plurality of keywords, each being comprised of one or more character portions. The replacement content generator may replace one or more character portions of one or more keywords with a visually identical replacement character(s). Visually identical replacement character may refer to a replacement character that appears identical to a character when rendered on a human readable user interface to be viewed by a user but that has a different computer encoding (e.g., a different Unicode encoding).

In some embodiments, the initial text includes one or more initial keywords, which are comprised of the initial content elements. The systems and methods for generating replacement content may include replacing each instance of the initial keyword with a different replacement keyword. For example, the systems and methods provided herein may include generating multiple replacement content elements for replacing a single initial keyword of the initial text, with each replacement keyword being visually identical to the initial keyword when rendered on a display screen but distinct from the initial keyword when processed by a machine (e.g., a computing device). For example, in some embodiments, tokenization of each replacement content element and/or each replacement keyword generates a different token as compared to other replacement content elements and/or replacement keywords for the same initial content elements and/or keyword. Replacing each instance of an initial keyword with a different replacement keyword generates replacement text that may be rendered visually identical to the initial text but that causes generation of multiple different tokens for each instance of the initial keyword in the initial text.

In some embodiments, the systems and methods discussed herein are directed to controlling which content is rendered on a user's device. For example, a user may transmit a request to view the initial text (e.g., including the initial content elements) from a user device. The request may be associated with a request type. The replacement content generator may determine whether the request type meets replacement text criteria or initial text criteria. When the request type meets replacement text criteria, the replacement content generator transmits the replacement text to the user's device in response to receiving the request to view the initial text. When the request type meets initial text criteria, the replacement content generator transmits the initial text to the user's device in response to receiving the request to view the initial text.

In some embodiments, the system includes a human readable user interface configured render and display the initial text and/or the replacement ext. For example, a user may submit a request via the human readable user interface to view the initial text. The replacement content generator may receive the request from the user and generate replacement text for the initial text. The replacement content generator may transmit the replacement text to the human readable user interface to display to the user. The replacement text may appear visually identical to the initial text when rendered on the human readable user interface and viewed by the user.

In some embodiments, the replacement content generator is configured to replace one or more initial content elements of one or more initial keywords with replacement elements to generate one or more replacement keywords. The replacement elements may include embeddings within the replacement keywords. In some embodiments, the replacement keywords appear identical to an initial keyword when rendered on a human readable user interface to be viewed by the user. The user may not be able to visually identify the embeddings within the replacement keyword. However, the embeddings may cause each replacement keyword to be processed differently by an automated process and/or may cause an output of an automated process to include the embeddings such that a content creator may be able to determine that their content has been utilized by the automated process (e.g., for a training a machine learning model). In some embodiments, the embeddings include one or more zero-width characters embedded into a replacement element. For example, the embedding may be a text string embedded in a replacement element.

Furthermore, in the following, various embodiments are described with respect to systems and methods for generating replacement text including at least one replacement element. In some embodiments, a method includes: storing, in a data store, initial text including a plurality of instances of at least one initial keyword; identifying, for the at least one initial keyword, at least two sets of replacement characters corresponding to at least one respective character portion of the initial keyword, wherein each of the at least two sets of replacement characters have a visually similar appearance to the at least one respective character portion of the initial keyword when rendered on a display; generating replacement text by for a first instance of the initial keyword in the initial text; replacing the at least one respective character portion of the initial keyword with a first set of replacement characters to generate a first replacement keyword, wherein a machine encoding of the initial keyword and a machine encoding of the first replacement keyword are distinct, for a second instance of the initial keyword in the initial text; replacing at least one respective character portion of the initial keyword with a second set of replacement characters to generate a second replacement keyword, wherein a machine encoding of the second replacement keyword is distinct from the machine encoding of the initial keyword and the machine encoding of the first replacement keyword; and generating instructions to display, via a human readable user interface, replacement text including the first replacement keyword and the second replacement keyword, wherein each of first replacement keyword, the second replacement keyword, and the initial keyword have a visually similar appearance when rendered on the human readable user interface.

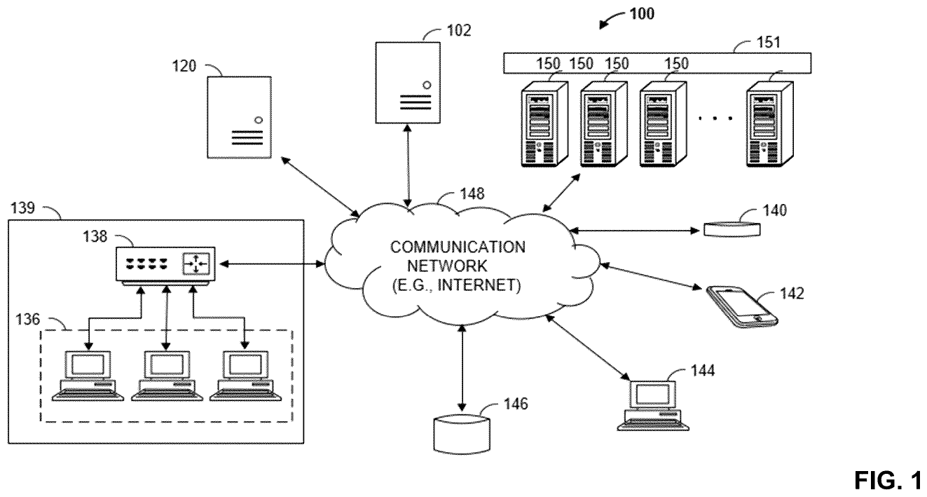

Referring to FIG. 1, the present disclosure is directed to a system 100 for generating replacement content. System 100 includes a plurality of devices or systems configured to communicate over one or more network channels, illustrated as a network cloud 148. For example, in various embodiments, the system 100 can include, but not limited to, content server 102 (e.g., a server, such as an application server), web server 140, criteria server 120, cloud-based engine 151 including one or more processing devices 150, workstation(s) 136, database 146 (e.g., data store), and one or more user computing devices 142, 144 operatively coupled over the network 148. Content server 102, web server 140, criteria server 120, workstation(s) 136, and multiple user devices 142, 144 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit and receive data over the communication network 148.

Content server 102 may be configured to communicate with database 146 and devices 142, 144 through network 148. For example, content server 102 may be configured to receive one or more requests from devices 142, 144, which each may include a human readable user interface. Content server 102 may be configured to store and receive data from database 146. In some embodiments, database 146 stores initial content elements and the initial keywords, each associated with the initial text. Database 146 may also store replacement text and data, such as replacement text generated by replacement content generator discussed herein. For example, database 146 may be store replacement characters, replacement elements, and/or replacement text generated by a replacement content generator.

In some embodiments, content server 102 includes a replacement content generator configured to parse initial text stored within database 146. The initial text may be content generated and/or configured to be published on a publicly accessible interface, such as a web interface or other interface accessible via the Internet. The replacement content generator may process (e.g., parse, tokenize, etc.) the initial text to identify one or more instances of an initial keyword, which is comprised of initial content elements. The replacement content generator may identify one or more character portions included in the initial keyword and replace the one or more character portions of the keyword with replacement characters, such one or more homoglyphs and/or one or more zero-width characters. For example, the replacement content generator may identify one or more respective homoglyphs (e.g., replacement characters) that correspond to the one or more character portions. The replacement character(s) may appear identical to the one or more character portions when rendered on a display screen of a user's device. In some embodiments, each instance of the initial keyword is replaced by a different permutation of the replacement element. Each replacement element may contain at least one different replacement character (e.g., homoglyph) and/or combination of replacement characters. The replacement content generator may replace each instance of the initial keyword with one of a plurality of permutations of a replacement keyword thereby generating replacement text. The replacement text may be visually identical to the initial text when rendered on a human readable user interface, but may be interpreted and/or converted different than the initial text by a machine.

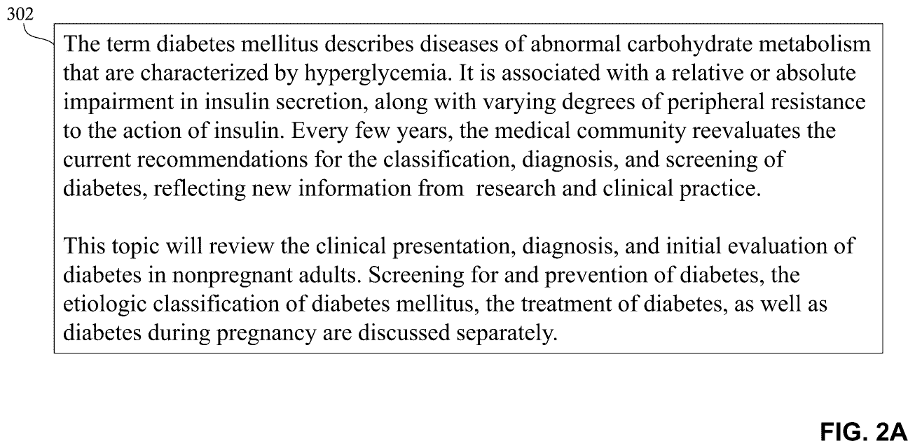

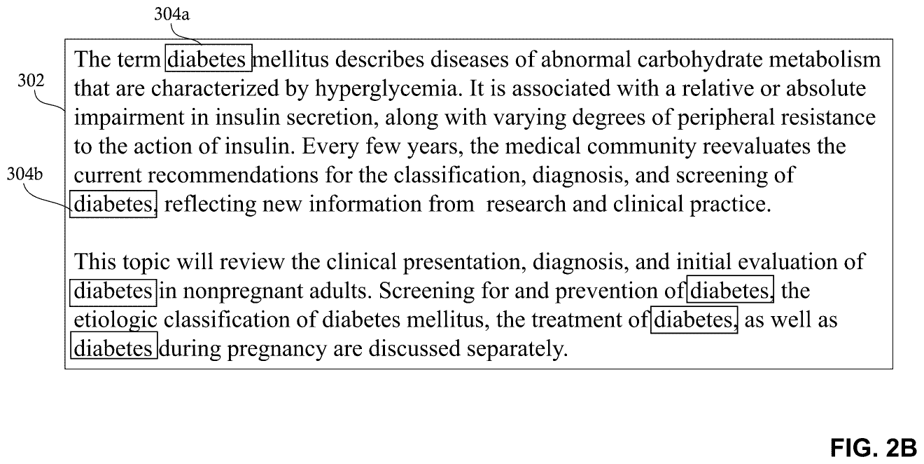

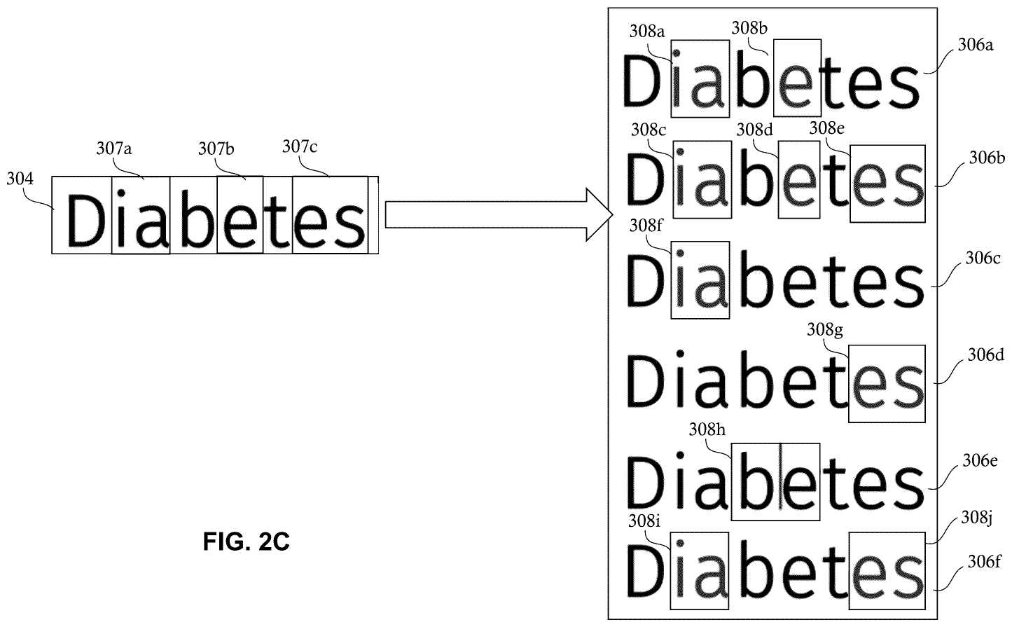

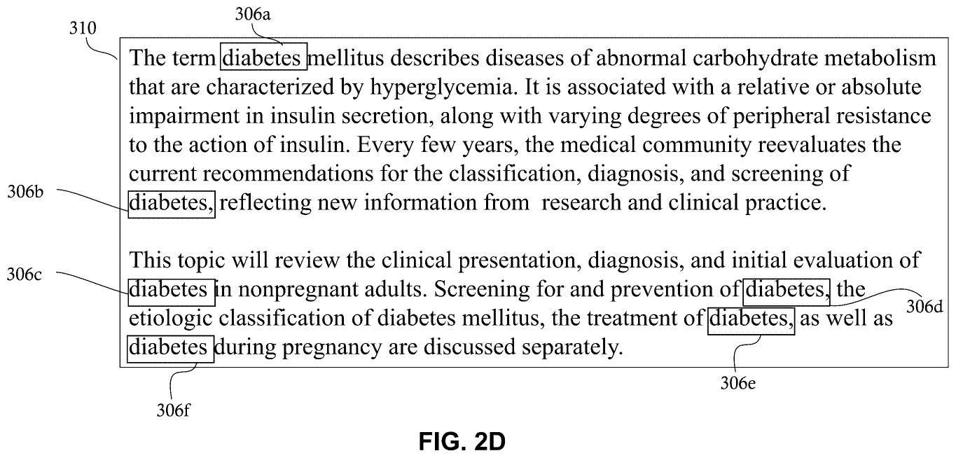

Referring to FIGS. 2A-2D, initial text 302 may be published for a user to view, read, and/or interact with on a human readable user interface (e.g., device 142, 144), such as within a network interface (e.g., Internet-based interface, internal knowledge base interface, etc.). Initial text 302 may be associated with one or more keywords or topics. The keyword(s) may be words that appear many times in initial text 302 and/or have significance within the initial text 302 such that the presence of the keyword(s) indicate to the user a topic of initial text 302. By way of an example, Initial text 302 may include multiple instances of the keyword “diabetes.” Initial text 302 may be associated with the keyword or topic of “diabetes” to indicate to a user that initial text 302 discusses diabetes. In some embodiments, a replacement content generator is configured to identify each instance of an initial keyword within initial text 302.

In some embodiments, a replacement content generator, for example as implemented by content server 102, identifies multiple instances of initial keyword 304 within initial text 302. For example, as illustrated in FIG. 2B, initial text 302 may include multiple instances of an initial keyword 304. The replacement content generator may identify one or more candidate character portions 307a-307c (e.g., initial content elements) within initial keyword 304. For example, as illustrated in FIG. 2C, a replacement content generator may identify character portions 307a-307c within initial keyword 304. Upon identifying one or more character portions 307a-307c, the replacement content generator may identify a respective homoglyph (e.g., replacement characters 308a-308g) to replace one or more of character portions 307a-307c. For example, for each instance of initial keyword 304, the replacement content generator may identify replacement characters 308a-308j (e.g., replacement elements), such as one or more homoglyphs, and replace the corresponding one or more character portions 307a-307c with the replacement characters 308a-308j to generate one or more replacement keywords 306a-306f. In some embodiments, the replacement content generator generates a plurality of replacement keyword 306a-306f, each having different replacement characters 308a-308j and/or combinations of replacement characters 308a-308j. For example, the replacement content generator may replace a first instance of initial keyword 304 with a first replacement keyword 306a and may replace a second instance of initial keyword 304 with a second replacement keyword 306b that is different than the first replacement keyword 306a (e.g., includes at least one replacement character 308a-308j not included in the first replacement keyword 306a).

In some embodiments, one or more replacement characters 308a-308g include homoglyphs of one or more characters of the initial keyword 304, e.g., one or more character portions 307a-307c. For example, replacement characters 308a-308g may include, but are not limited to, homoglyphs of one or more character portions 307a-307c (e.g. one or more characters or combinations of characters) such that when rendered on a human readable user device, the homoglyph (e.g., replacement character 308a-308g) and the corresponding character portion 307a-0307c are visually identical. When interpreted by a machine, such as through tokenization of words and/or characters, the replacement keywords 306a-306f containing one or more replacement characters 308a-308j will generate different values (e.g., different tokens) when parsed.

In some embodiments, the replacement content generator replaces one or more character portions 307a-307c (e.g., initial content elements) of each nth instance of initial keyword 304 with an nth replacement element including a set of replacement characters 308a-308j (e.g., one or more homoglyphs, one or more zero-width characters, etc.) such that each set of n replacement keywords 306a-306f are comprised of different replacement characters 308a-308j. For example, the replacement content generator may identify three instances of initial keyword 304 within initial text 302—first instance, second instance, and third instance. The replacement content generator may identify one or more character portions of the initial keyword having a respective homoglyph that corresponds to the respective character portion of initial keyword. The replacement content generator may replace one or more character portions of the first instance with a first homoglyph (or first set of homoglyphs) to generate first replacement keyword, one or more character portions of the second instance with a second homoglyph (or second set of homoglyphs) to generate second replacement keyword, and one or more character portions of the third instance with a third homoglyph (or third set of homoglyphs) to generate third replacement keyword. Although embodiments are discussed herein including certain numbers of replacement elements (e.g., replacement characters), it will be appreciated that a set of n replacement elements may include any number of replacement elements having any suitable number and/or combination of replacement characters, such as one or more homoglyphs and/or one or more zero-width characters.

Referring to FIGS. 2C-2D, an example is shown of generating replacement keywords 306a-306f based on initial keyword 304. The replacement content generator may identify “diabetes” as initial keyword 304 within initial text 302. The replacement content generator may parse “diabetes” and identify one or more character portions 307a-307c (e.g., “ia”, “e”, “es”) suitable for replacement by one or more replacement characters within initial keyword 304. The replacement content generator may identify one or more replacement characters 308a-308j (e.g., homoglyphs, characters including zero-width embeddings, etc.) that correspond to one of the identified character portions 307a-307c of initial keyword 304. The replacement content generator may then generate one or more replacement keywords 306a-306f by substituting at least one instance of an identified character portion 307a-307c with replacement characters 308a-308j. For example, a first replacement keyword 306a may include two replacement characters 308a, 308b replacing character portions 307a and 307b, a second replacement keyword 306b may include three replacement characters 308c-308e replacing character portions 307a-307c, a third replacement keyword 306c may include two replacement characters replacing a single character portion 307a, etc. Any number of character portions 307 may be replaced by replacement characters 308a-308j. The replacement content generator may replace one or more instances of initial keyword 304 with different replacement keywords 306a-306f to generate replacement text 310. In some embodiments, the number of instances of initial keyword 304 in initial text 302 is the same as the number of permutations of replacement keyword 306a-306f generated by the replacement content generator. In such embodiments, each instance of initial keyword 304 in initial text 302 is replaced with a different permutation of replacement keyword 306a-306f in replacement text 310. However, as will be appreciated, in some embodiments, initial text 302 may contain more instances of initial keyword 304 than the number of replacement keywords 306a-306f in a set of replacement keywords. In such embodiments, each nth instance of the initial keyword 304 may be replaced with an nth replacement keyword 306a-306f, may be replaced with a randomly selected replacement keyword 306a-306f, etc.

The replacement text 310 is configured to prevent, poison, or otherwise defeat automated processing of the initial text by one or more machine processes. For example, tokenization of each replacement keyword 306a-306f generates a different token and prevents generation of associations between instances of the keyword. During typical tokenization processes, multiple instances of a single word, such as each instance of an initial keyword 304 in initial text 302, results in a single, classifiable token being generated. The generated token is usable by machine learning processes, such as LLM processes, to generate inferences and/or extract information from the initial text 302 regarding and/or including the initial keyword 304. In contrast, tokenization of replacement text 310 results in a different token being generated for each replacement keyword 306a-306f, as each replacement keyword 306a-306f has a different machine representation (e.g., different set of Unicode encodings, different binary value, etc.) and therefore generates a different token as compared to other replacement keywords 306a-306f and/or the initial keyword 304. When tokenizing a replacement text 310, a different token will be generated for two or more instances of a keyword, e.g., an initial keyword 304 that is replaced with replacement keywords 306a-306f. Generation of multiple, distinct tokens for each instance of a keyword may prevent a machine learning model, algorithm, or other automated process from using replacement text 310 for automated processes, such as training, ingestion, classification, etc.

Conventionally, a machine learning model processing a text for training purposes must convert (e.g., tokenize) each word and/or character of the text for further processing. The converted representations (e.g., tokens) are utilized to generate keyword associations, topic associations, interpret text, generate text, etc. Typically, the machine learning model is able to identify associations between instances of a keyword due to the same token being generated for all initial keywords within the text, allowing the machine learning model to make associations between keywords within the text and topics. By way of an example, a machine learning model processing initial text 302 will generate the same token for each instance of the word “diabetes” (e.g., initial keyword 304) in the initial text 302. For tokenization of initial text 302, the machine learning model may generate a single token for the seven instances of the term “diabetes” and may generate an association between the token and surrounding words of initial text 302 (e.g., “screening”, “classification”, “treatment”, “mellitus”, “pregnancy”, “prevention”, etc.). The associations between each instance of a keyword and words or characters around each instance of the keyword allows the machine learning model to learn and build associations between the term “diabetes” and the other words of initial text 302, extracting information from the text, and enabling additional processes, such as ingestion, summarization, output generation, etc.

Using the disclosed method, a machine learning model may be prevented from identifying associations between instances of one or more keywords and/or surrounding text. For example, tokenization of replacement text 310 results in a different token being generated for each replacement keyword 306a-306f in a set of replacement keywords 306a-306f used in the replacement text 310. Generation of different tokens for different instances of a keyword prevents associations between instances of a keyword and/or with words around instances of a keyword, obstructing the machine learning model's ability to generate associations between a keyword and surrounding text and/or perform additional tasks. As one example, tokenization of a replacement text 310 including an initial keyword 304 and six permutations of replacement keyword 306a-306f results in seven different tokens being generated (compared a single token for initial text 302). Generation of seven different tokens prevents associations between instances of keywords 304, 306a-306f and prevents connection of associations for surrounding terms, which obstructs the learning and training of the machine learning model. For example, while a first token may be associated with the term “treatment”, a second token may be associated with the term “screening”, a third token may be associated with the term “prevention”, a fourth may be associated with the term “pregnancy”, a fifth token may be associated with the term “mellitus”, a sixth may be associated with the term “classification”, and a seventh token may be associated with the term “etiologic,” the uniqueness of each token prevents the automated process from establishing associations between each of the additional terms and/or between each instance of the keyword. Thus, processing of the replacement text 310 results in seven separate terms, each having an association with a single additional term, but no associations between each instance of the keyword 304, 306a-306f (as compared to a single association during tokenization of initial text 302), which disrupts training of a machine learning model.

In some embodiments, at least one replacement character set 308h includes at least one zero-width element (e.g., one or more zero-width characters, zero-width text, zero-width images, etc.). For example, zero-width elements may be embedded into one or more replacement character sets 308h and/or replacement keywords 306e. In some embodiments, the zero-width elements includes a text string. The text string may be searchable and/or identifiable within machine output in order to determine when content has been used by another application, model, and/or other unauthorized process (e.g., machine learning training, algorithm generation, summarization, etc.). For example, an unauthorized party may use (e.g. tokenize, ingest, summarize, etc.) content through one or more automated processes, such as a machine learning process. At least one replacement keyword 306e including an embedded text string (e.g., as zero-width text) may cause outputs from the unauthorized process (or downstream processes based on the unauthorized process) to reproduce and/or include the text string, allowing for identification of processes (e.g., machine learning processes and/or other computer processes) that have used the content without permission.

As one non-limiting example, in some embodiments, one or instances of an initial keyword 304 may be replaced with a replacement keyword 306e including a zero-width text string stating “Property of XXX Corp., ©2024”. Ingestion and use of replacement text including one or more instances of the replacement keyword 306e including the zero-width text string may cause outputs of certain processes, such as large language models, to include the zero-width text string, for example, as visible and/or non-visible characters. An owner of the initial text 302 may conduct searches and/or other investigations of output from certain processes, such as large language models, that search for the embedded string. When the string is identified, the owner of the initial text 302 can identify that the initial text 302 was used as part of a process to generate the output.

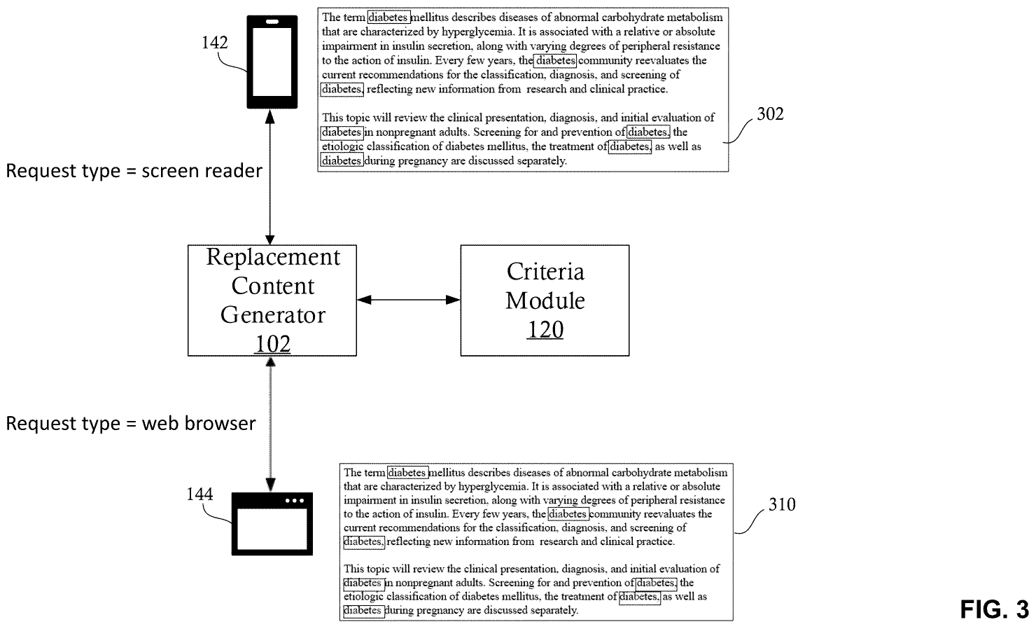

Referring to FIG. 3, the replacement content generator may be configured to selectively provide one of initial text 302 or replacement text 310 to a device in response to a request for content or text. In some embodiments, a user device (e.g., device 142 or 144) transmits a request to content server 102 to obtain content for presentation to a user via a user device. Presentation of content may include visual presentation, e.g., enabling a user to view content on a human readable user interface of a user device, audio presentation, e.g., enabling a user to hear an audible version of content such as generated by a screen reading process, tactile presentation, e.g., enabling a user to feel a tactile version of content such as generated by a brail reading device, etc. The request generated by the user device may include a request type identifying the type of output to be generated by the user device. The content server 102 may receive a request including a request type and may transmit the request type to criteria server 120.

Criteria server 120 may include a criteria module configured to compare the request type to criteria, e.g., replacement content criteria, initial content criteria, etc., to determine which version of content to provide to the user device. For example, replacement content criteria may be met when a request type is associated with visual rendering of the content, e.g., rendering of content via a web browser, a mobile browser, a human readable display, etc. Replacement content criteria may similarly be met when the request type indicates a request by a machine learning model application, a machine training application, a web scraping application, etc. Further, the replacement content criteria may be met if the request type is associated with an untrusted device, an unauthorized device, or an uncertified device. In some embodiments, the initial content criteria is met if the request type is associated with a non-visual output mechanism, such as an electronic reader (e.g., mobile e-reader, screen reader), tactile output, etc. The initial content criteria may similarly be met if the request type is associated with a trusted device, an authorized device, a certified device, etc.

In some embodiments, criteria server 120 determines when the request type meets the replacement content criteria or the initial content criteria and transmits the determination to the content server 102. For example, a criteria module may tag the request with a replacement text tag indicating the request type meets the replacement content criteria or an initial text tag indicating the request type meets the initial content criteria. Upon receiving the tagged request from the criteria server 120, the content server 102 may transmit replacement text 310 if the request is tagged with the replacement text tag and may transmit initial text 302 if the request type is tagged with the initial text tag. In some embodiments, when a determination is not provided, the content server 102 may default to providing one of the replacement text 310 or the initial text 302.

By way of an example, device 142 may include a screen reader process and device 144 may include a web browser utilizing a web scraping application. Device 142 may transmit a first request to view initial text (e.g., initial text 302) to the content server 102. The first request may have a first request type indicating the content is for a screen reader process. Device 144 may transmit a second request to view initial text (e.g., initial text 302) to the content server 102. The second request may have a second request type indicating the content is for a web scraping process. The content server 102 may transmit the first request type and the second request type to the criteria server 120. Criteria server 120 may tag the first request type with an initial text tag since first request type is associated with a screen reader process. In some embodiments, based on first request type being associated with a screen reader process, a criteria module may determine that device 142 is a trusted device. The criteria server 120 may tag the second request with a replacement text tag since second request type is associated with a web browser utilizing a web scraping application. In some embodiments, based on second request type being associated with a web browser utilizing a web scraping application, a criteria module may determine that device 144 is an untrusted device. The criteria server 120 may transmit the tagged first request and the tagged second request to the content server 102. Based on the received tagged request, the content server 102 may transmit initial text (e.g., initial text 302) to device 142 for audible rendering by the screen reading process and may transmit replacement text (e.g., replacement text 310) to device 144. When rendered on a display screen (e.g., of device 142 and/or device 144), the initial text and the replacement text look the same.

In some embodiments, a user utilizing a user device that received replacement text (e.g., replacement text 310) may desire to perform a search, using a search function of their device, within the replacement text. However, due to the replacement text including replacement elements that will be parsed and/or interpreted differently by a machine process, the search may be unable to find certain instances of searched word, such as a replaced keyword. In some embodiments, the content server 102, upon receiving an indication that a search is to be performed on replacement text (e.g., from a search function of the user device), may recall the initial text (e.g., initial text 302) and perform a search on the initial text. In some embodiments, the content server 102 displays, on the user device, the initial text during the search to allow the user to search for keywords. When the search function is complete, the content server 102 may cause the user device to go back to displaying the replacement text (e.g., replacement text 310).

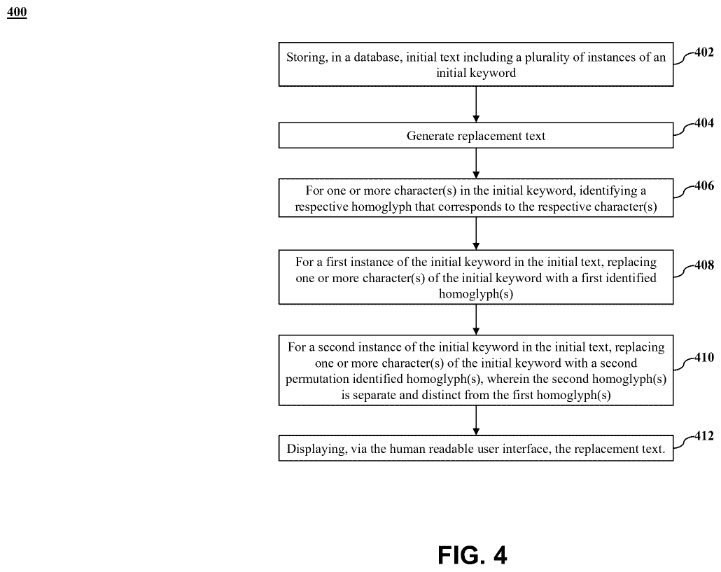

Referring to FIG. 4, a method of generating and providing replacement content is shown. At step 402, the initial text (e.g., initial text 302 of FIG. 2A) is stored within a data store. The initial text may include a plurality of instances of an initial keyword, such as initial keyword 304 of FIG. 2B. In some embodiments, the initial text includes a first instance of the initial keyword, a second instance of the initial keyword, an nth instance of the initial keyword, etc. The initial text may include N number of instances of the initial keyword, where N is an integer greater than 0.

At step 404, replacement text (e.g., replacement text 310 of FIG. of 2D) is generated. For example, a replacement content generator may identify multiple instances of an initial keyword (e.g., initial keyword 304 of FIG. 2B) in initial text 302. In some embodiments, initial text 302 includes multiple instances of multiple keywords and each may identified by replacement content generator for replacement. The replacement content generator may identify a number (N) of instances for each of a plurality of initial keywords.

Generation of the replacement text may include identifying character portions within an initial keyword at step 406. For example, a replacement content generator may parse the initial keyword to identify one or more character portions (e.g., character portions 307a-307d of initial keyword 304 of FIG. 2C). The replacement content generator may parse the initial keyword to determine each character or combination of characters that comprises the initial keyword. In some embodiments, the replacement content generator identifies a replacement character (or set of replacement characters) for one or more identified characters (or set of characters) comprising the initial keyword. For example, the replacement content generator may identify a respective replacement character (e.g., replacement character 308a of FIG. 2C) for each character portion (e.g., character portion 307a). In some embodiments, the replacement character is a homoglyph of the identified character(s) in the initial text. The replacement content generator may identify one or more respective homoglyphs that correspond to one or more respective characters of initial keyword. In some embodiments, the respective homoglyphs are visually identical to the corresponding characters when viewed on a human readable user interface but generates a different encoding or output when interpreted by a machine.

In some embodiments, a homoglyph includes a different font type or language type than the corresponding character(s) of the initial keyword. For example, for initial text provided in a Roman script, a homoglyph may be a Cyrillic character that is visually identical when viewed on a human readable user interface. The homoglyph may be any language type, script type, and/or font type that provides a visually identical character when viewed on a human readable user interface to the corresponding character(s) of the initial text.

In some embodiments, multiple permutations of replacement characters (e.g., replacement elements), such as homoglyphs, are generated for each of one or more corresponding character portions. For example, as shown in FIG. 2C, four different homoglyphs may be identified for a character portion 307a of “ia” resulting in the “ia” of replacement keyword 306a having a first homoglyph, the “ia” of replacement keyword 306b having a second homoglyph, the “ia” of replacement keyword 306c having a third homoglyph, and the “ia” of replacement keyword 306f having a fourth homoglyph. Continuing with the example above, each of the first homoglyph, the second homoglyph, the third homoglyph, and the fourth homoglyph may be visually identical to each other when rendered a human readable user interface and may be visually identical to the character portion 307a “ia” when rendered a human readable user interface (as shown in FIG. 2C).

At step 408, one or more character portions of a first instance of the initial keyword are replaced with a first homoglyph. For a first instance of the initial keyword, such as initial keyword 304a of FIG. 2B, a replacement content generator may replace a first character portion, e.g., “ia,” with a first set of homoglyphs to generate a replacement keyword (e.g., replacement keyword 306a). In some embodiments, multiple character portions of the initial keyword may be replaced with homoglyphs, for example, replacing a first character portion 307a with a first set of homoglyphs (e.g., replacement characters 308a) of the first character portion 307a and a second character portion 307b with a second set of homoglyphs (e.g., replacement characters 308b) of the second character portion 307b. One or more character portions 307a-307c of the initial keyword may be replaced with one or more identified homoglyphs to generate a replacement keyword. The replacement keyword is visually identical to the initial keyword when rendered on a human readable visual user interface.

In some embodiments, at step 410, multiple permutations of homoglyphs are identified for one or more character portions of initial keyword 304 and at least a second replacement keyword is generated. For example, a replacement content generator may generate a first replacement keyword 306a by utilizing a first set of homoglyphs corresponding to a first character portion “ia” 307a and a first set of homoglyph(s) corresponding to character portion “e” 307b of replacement keyword 306a. The replacement content generator may generate a second replacement keyword 306b using, for example, the first set of homoglyph(s) corresponding to the first character portion “ia” 307a and a second set of homoglyphs corresponding to character portion “e” 307b. As another example, the second replacement keyword 306b may include a second set of homoglyphs corresponding to the first character portion “ia” 307a and one of the first set or the second set of homoglyphs corresponding to character portion “e” 307b. This allows replacement content generator to generate multiple permutations of replacement keywords.

In some embodiments, permutations of homoglyphs are generated to replace one or more character portions 307a-307c of the initial keyword 304. For example, a first set of homoglyphs and a second set of homoglyphs may be generated for a first character portion 307a of the initial keyword 304. As shown in FIG. 2C, a first replacement keyword 306a may include the first set of homoglyphs and a second replacement keyword 306b may include the second set of homoglyphs such that each of the replacement keywords 306a, 306b are visually identical to initial keyword 304 and to each other when rendered on a human readable visual user interface. A set of N permutations of replacement keywords 306a-306f (e.g. utilizing different set of homoglyphs for one or more character portions) may be generated. In some embodiments, the number of replacement keywords N is equal to the number of instances of initial keyword 304 within the initial text 302.

In some embodiments, the second set of homoglyphs includes separate and distinct characters from the first set of homoglyphs, such that a second instance of a keyword within replacement text 310 is mechanically (e.g., when interpreted by a machine, computer, process, etc.) separate and distinct from a first instance of the keyword within replacement text 310 while appearing visually similar to the first instance of the initial keyword when rendered on a human readable visual user interface. In some embodiments, at least one instance of a replacement keyword in the replacement text is identical to the initial keyword 304 (e.g., does not contain any replacement characters (homoglyphs, zero-width characters, etc.)).

With reference to FIGS. 2B and 2D, a replacement content generator may identify a first instance of initial keyword 304a and a second instance of initial keyword 304b of an initial keyword 304 within initial text 302. For the first instance of initial keyword 304a, one or more first sets of homoglyphs may be identified and one or more character portions within the first instance of the initial keyword 304a replaced with the homoglyphs of the first sets to generate a replacement keyword 306a. For the second instance of initial keyword 304b, one or more second sets of homoglyphs may be identified and one or more character portions within the second instance of initial keyword 304b replaced with the homoglyphs of the second sets to generate a replacement keyword 306b. When rendered on a visual output device, the first replacement keyword 306a and the second replacement keyword 306b are visually identical to each other and to the initial keyword 304. When interpreted by a machine, each of the initial keyword 304, the first replacement keyword 306a, and the second replacement keyword 306b are different.

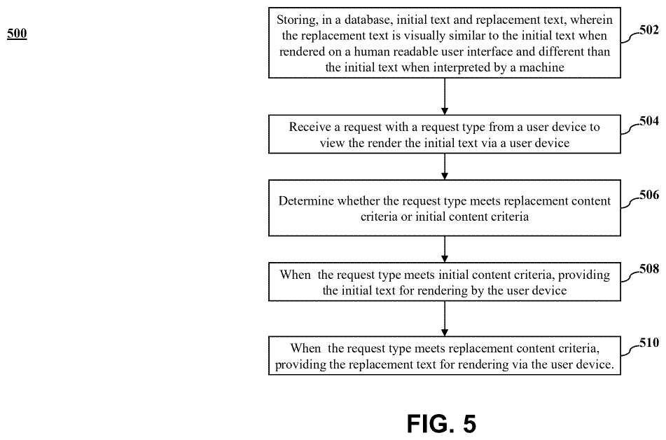

At step 412, instructions are generated to cause a visual output device of a human readable user interface (e.g., user interface of device 142, 144) to display the replacement text 310. The instructions may be generated in response to a request for the initial text 302, for example, as discussed in greater detail with respect to FIG. 5.

Referring to FIG. 5, a method of selectively providing replacement text is disclosed, in accordance with some embodiments. At step 502, initial text (e.g., initial text 302 of FIG. 2A) and replacement text (e.g., replacement text 310 of FIG. 2D) may each be stored within a data store. The initial text and the replacement text are visually similar or identical when rendered on a human readable user interface. The replacement text includes one or more replacement keywords that are interpreted differently by a machine as compared to an initial keyword of the initial text and may be generated according to the processes discussed herein, such as, for example, the method 400 discussed above with respect to FIG. 4.

At step 504, a request for textual content is received from a user device (e.g., device 142, 144). The request may be associated with a request type. For example, as illustrated in FIG. 3, device 142 may transmit a request having a request type indicating a request related to a screen reader process. As another example, device 144 may transmit a request having a request type indicating a request related to a web browser. The request may be transmitted from the user device having a human readable user interface (e.g., device 142, 144). The request may be a request to render the initial text (e.g., initial text 302) via the user device. The request may be received by any suitable system, such as a server 120

At step 506, server 120 determines whether the request meets replacement content criteria or initial content criteria. Server 120 may include a content criteria module configured to receive the request and determine whether the request meets replacement content criteria or initial content criteria. The criteria module may compare the request type to one or more type criteria. In some embodiments, replacement content criteria is met when the request type indicates a request related to a web browser, web scraping application, machine learning or training application, mobile browser, visual rendering process, etc. As another example, in some embodiments, initial content criteria may be met when the request type indicates a request related to a non-visual rendering of the requested content, such as via an audio rendering (e.g., screen reader or electronic reader), a tactile rendering (e.g., via a tactile interface), and/or any other suitable non-visual rendering. In some embodiments, user device (e.g., device 142, 144) includes one or more certifications that are transmitted and/or utilized in conjunction with the request to associate the user device with initial content criteria. The one or more certifications may indicate that the user device (e.g., device 142, 144) is a trusted, authorized, or certified device.

Although embodiments are discussed herein including both replacement content criteria and initial content criteria, it will be appreciated that a criteria module may implement only one set of criteria to determine whether to provide replacement text or initial text in response to a request. For example, in some embodiments, the criteria module may implement a set of initial content criteria to determine when a request is authorized to receive initial content. When initial content criteria is not met, the content module may default to a replacement content tag and/or replacement text may be transmitted by the content server 102 unless an initial text tag is expressly received. Similarly, as another example, the criteria module may implement a set of replacement content criteria to determine when a request should receive replacement text. When replacement content criteria is not met, the content module may default to an initial text tag and/or initial text may be transmitted by the content server 102 unless a replacement text tag is expressly received.

At step 508, when the criteria module determines that the request meets initial content criteria, the criteria module tags or otherwise associates the request with initial text and transmits the associated request to a content providing server, such as, for example, content server 102. In response, content server 102 may generate instructions that cause the user device to render the initial text on the display screen of the user device. The instructions may include the initial text or instructions to retrieve the initial text from the data store.

For example, with reference to FIG. 3, device 142 may transmit a request having a request type indicating the request is related to a screen reader process. The request may be received by content server 102 and transmitted to server 120 including a criteria module. The criteria module may determine that the request meets the initial content criteria based on the a request type indicating a screen reader process. In response, the criteria module tags the request from device 142 with an initial text tag and transmits the tagged request to content server 102. In response to receiving the tagged request, content server 102 transmits initial text (e.g., initial text 302) to device 142. In some embodiments, due to the request type of device 142 indicating device 142 is a screen reader, the criteria module may further determine that device 142 is a trusted, authorized, or certified device. Future requests from device 142 may be tagged with an initial text tag based on a trusted status of device 142.

At step 510, when the criteria module determines that a request meets replacement content criteria (or alternatively does not meet initial content criteria), the criteria module may tag the request type with replacement text tag and transmit the request tagged with the replacement text tag to content server 102. In response, content server 102 may generate instructions that cause the user device to render the replacement text on the display screen of the user device. The instructions may include the replacement text or instructions to retrieve the replacement text from the data store.

For example, and with reference to FIG. 3, device 144 may transmit a request having a request type related to a web browser. The request may be received by content server 102 and transmitted to server 120. A criteria module may determine that the request from device 144 meets replacement content criteria due to the request type indicating a web browser. In response, the criteria module tags the request from device 144 with a replacement text tag and transmits the tagged request to content server 102. In response to receiving the tagged request, content server 102 transmits replacement text (e.g., replacement text 310) to device 144. As illustrated in FIG. 3, content server 102 may cause device 144 to display replacement text 310 in response to the request having a request type indicating that a web browser. In some embodiments, due to the request type of the request, the criteria module may determine that device 144 is an untrusted, unauthorized, or uncertified device. Future requests from device 144 may be tagged with a replacement text tag based on the untrusted status of device 144.

Returning to FIG. 1, FIG. 1 is a network environment or system 100 configured to provide replacement text, in accordance with some embodiments of the present teaching. In some examples, each of content server 102 and the processing device(s) 150 can be a computer, a workstation, a laptop, a server such as a cloud-based server, or any other suitable device. In some examples, each of the processing devices 150 is a server that includes one or more processing units, such as one or more graphical processing units (GPUs), one or more central processing units (CPUs), and/or one or more processing cores. Each processing device 150 may, in some examples, execute one or more virtual machines. In some examples, processing resources (e.g., capabilities) of the one or more processing devices 150 are offered as a cloud-based service (e.g., cloud computing). For example, the processing devices 150 may offer computing and storage resources of the one or more processing devices 150 to content server 102.

In some examples, each of the multiple user devices 142, 144 can be a cellular phone, a smart phone, a tablet, a personal assistant device, a voice assistant device, a digital assistant, a laptop, a computer, or any other suitable device. In some examples, the web server 140 hosts one or more websites providing content to users. In some examples, content server 102, the processing devices 150, and/or the web server 140 are operated by a user or business. The multiple user computing devices 142, 144 may be operated by users interacting with a platform of a business. In some examples, the processing devices 150 are operated by a third party (e.g., a cloud-computing provider).

The workstation(s) 136 are operably coupled to the communication network 148 via a router (or switch) 108. The workstation(s) 136 and/or the router 108 may be remotely from the content server 102, for example. The workstation(s) 136 can communicate with content server 102 over the communication network 148. The workstation(s) 136 may send data to, and receive data from, content server 102.

Although FIG. 1 illustrates two user computing devices 142, 144, system 100 can include any number of user devices 142, 144. Similarly, system 100 can include any number of content server 102, the processing devices 150, the workstations 136, the web servers 134, the databases 146, etc.

The communication network 148 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 148 can provide access to, for example, the Internet.

In some embodiments, each of the first user device 142, the second user device 144, and the Nth user device may communicate with the web server 140 over the communication network 148. For example, each of the multiple computing devices 142, 144 may be operable to view, access, and interact with a website, such as a content provider's website hosted by the web server 140.

Content server 102 is further operable to communicate with the database 146 over the communication network 148. For example, content server 102 can store data to, and read data from, the database 146. The database 146 can be a remote storage device, such as a cloud-based server, a disk (e.g., a hard disk), a memory device on another application server, a networked computer, or any other suitable remote storage. Although shown remote to content server 102, in some examples, the database 146 can be a local storage device, such as a hard drive, a non-volatile memory, or a USB stick. Database 146 may be coupled to a computing device. For example, database 146 may be coupled to one or more user devices 142, 144 via communication network 148.

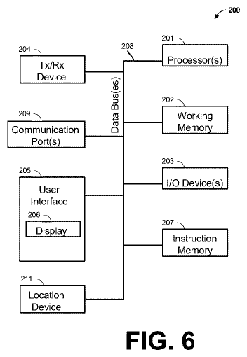

FIG. 6 illustrates a block diagram of a system 200, in accordance with some embodiments. In some embodiments, each of the content server 102, the criteria server 120, the web server 140, the multiple user devices 142, 144, and the one or more processing devices 150 in FIG. 1 may include the features of system 200 shown in FIG. 6. Although FIG. 6 is described with respect to certain components shown therein, it will be appreciated that the elements of the system 200 can be combined, omitted, and/or replicated. In addition, it will be appreciated that additional elements other than those illustrated in FIG. 6 can be added to the system 200.

As shown in FIG. 6, system 200 can include one or more processors 201, an instruction memory 207, a working memory 202, one or more input/output devices 203, one or more communication ports 209, a transceiver 204, one or more user interface devices 205, a display 206, and an optional location device 211, all operatively coupled to one or more data buses 208. The data buses 208 allow for communication among the various components. The data buses 208 can include wired, or wireless, communication channels.

The one or more processors 201 can include any processing circuitry operable to control operations of content server 102. In some embodiments, the one or more processors 201 include one or more distinct processors, each having one or more cores (e.g., processing circuits). Each of the distinct processors can have the same or different structure. The one or more processors 201 can include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 201 may also be implemented by a controller, a microcontroller, an application specific integrated circuit (ASIC), a field programmable gate array (FPGA), a programmable logic device (PLD), etc.

In some embodiments, the one or more processors 201 are configured to implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 207 can store instructions that can be accessed (e.g., read) and executed by at least one of the one or more processors 201. For example, the instruction memory 207 can be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 201 can be configured to perform a certain function or operation by executing code, stored on the instruction memory 207, embodying the function or operation. For example, the one or more processors 201 can be configured to execute code stored in the instruction memory 207 to perform one or more of any function, method, or operation disclosed herein.

Additionally, the one or more processors 201 can store data to, and read data from, the working memory 202. For example, the one or more processors 201 can store a working set of instructions to the working memory 202, such as instructions loaded from the instruction memory 207. The one or more processors 201 can also use the working memory 202 to store dynamic data created during one or more operations. The working memory 202 can include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 207 and working memory 202, it will be appreciated that the content server 102 can include a single memory unit configured to operate as both instruction memory and working memory. Further, although embodiments are discussed herein including non-volatile memory, it will be appreciated that computing system 200 can include volatile memory components in addition to at least one non-volatile memory component.

In some embodiments, the instruction memory 207 and/or the working memory 202 includes an instruction set, in the form of a file for executing various methods, e.g. any method as described herein. The instruction set can be stored in any acceptable form of machine-readable instructions, including source code or various appropriate programming languages. Some examples of programming languages that can be used to store the instruction set include, but are not limited to: Java, JavaScript, C, C++, C#, Python, Objective-C, Visual Basic, .NET, HTML, CSS, SQL, NOSQL, Rust, Perl, etc. In some embodiments a compiler or interpreter is configured to convert the instruction set into machine executable code for execution by the one or more processors 201.

The input-output devices 203 can include any suitable device that allows for data input or output. For example, the input-output devices 203 can include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 204 and/or the communication port(s) 209 allow for communication with a network, such as the communication network 148 of FIG. 1. For example, if the communication network 148 of FIG. 1 is a cellular network, the transceiver 204 is configured to allow communications with the cellular network. In some embodiments, the transceiver 204 is selected based on the type of the communication network 148 content server 102 will be operating in. The one or more processors 201 are operable to receive data from, or send data to, a network, such as the communication network 148 of FIG. 2, via the transceiver 204.

The communication port(s) 209 may include any suitable hardware, software, and/or combination of hardware and software that is capable of coupling the content server 102 to one or more networks and/or additional devices. The communication port(s) 209 can be arranged to operate with any suitable technique for controlling information signals using a desired set of communications protocols, services, or operating procedures. The communication port(s) 209 can include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 209 allows for the programming of executable instructions in the instruction memory 207. In some embodiments, the communication port(s) 209 allow for the transfer (e.g., uploading or downloading) of data, such as machine learning model training data.

In some embodiments, the communication port(s) 209 are configured to couple content server 102 to a network. The network can include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments can include in-body communications, various devices, and various modes of communications such as wireless communications, wired communications, and combinations of the same.

In some embodiments, the transceiver 204 and/or the communication port(s) 209 are configured to utilize one or more communication protocols. Examples of wired protocols can include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols can include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The user interface devices 205 may include any suitable human-machine interface, such as, for example, a visual display 206, an audible interface device (e.g., voice interface), a tactile interface device, etc. The display 206 can be any suitable display, such as a display configured to generate a human readable output. The user interface devices 205 can enable user interaction with content server 102 and/or the web server 140. For example, the user interface devices 205 can be a user interface for an application of a network environment operator. In some embodiments, a user can interact with the user interface devices 205 by engaging the input-output devices 203. In some embodiments, the display 206 can be a touchscreen.

The display 206 can include a screen such as, for example, a Liquid Crystal Display (LCD) screen, a light-emitting diode (LED) screen, an organic LED (OLED) screen, a movable display, a projection, etc. In some embodiments, the display 206 can include a coder/decoder, also known as Codecs, to convert digital media data into analog signals. For example, the visual peripheral output device can include video Codecs, audio Codecs, or any other suitable type of Codec.

The optional location device 211 may be communicatively coupled to a location network and operable to receive position data from the location network. For example, in some embodiments, the location device 211 includes a GPS device configured to receive position data identifying a latitude and longitude from one or more satellites of a GPS constellation. As another example, in some embodiments, the location device 211 is a cellular device configured to receive location data from one or more localized cellular towers. Based on the position data, the system 200 may determine a local geographical area (e.g., town, city, state, etc.) of its position.

In some embodiments, system 200 is configured to implement one or more modules or engines, each of which is constructed, programmed, configured, or otherwise adapted, to autonomously carry out a function or set of functions. A module/engine can include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine can also be implemented as a combination of the two, with certain functions facilitated by hardware alone, and other functions facilitated by a combination of hardware and software.

Although the methods described above are with reference to the illustrated flowcharts, it will be appreciated that many other ways of performing the acts associated with the methods can be used. For example, the order of some operations may be changed, and some of the operations described may be optional.

The methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

Each functional component described herein can be implemented in computer hardware, in program code, and/or in one or more computing systems executing such program code as is known in the art. As discussed above with respect to FIG. 6, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIG. 6.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of exemplary embodiments, it is not limited thereto. Rather, the appended claims should be construed broadly, to include other variants and embodiments, which can be made by those skilled in the art.

1. A system, comprising:
a data store storing initial text including a plurality of instances of at least one initial keyword;
a computing device comprising at least one processor in communication with the data store, the computing device being configured to:
identify, for the at least one initial keyword, at least two sets of replacement characters corresponding to at least one respective character portion of the initial keyword, wherein each of the at least two sets of replacement characters have a visually similar appearance to the at least one respective character portion of the initial keyword when rendered on a display;
generate replacement text by:
for a first instance of the initial keyword in the initial text, replacing the at least one respective character portion of the initial keyword with a first set of replacement characters to generate a first replacement keyword, wherein a machine encoding of the initial keyword and a machine encoding of the first replacement keyword are distinct;
for a second instance of the initial keyword in the initial text, replacing at least one respective character portion of the initial keyword with a second set of replacement characters to generate a second replacement keyword, wherein a machine encoding of the second replacement keyword is distinct from the machine encoding of the initial keyword and the machine encoding of the first replacement keyword; and
generate instructions to display, via a human readable user interface, replacement text including the first replacement keyword and the second replacement keyword, wherein each of first replacement keyword, the second replacement keyword, and the initial keyword have a visually similar appearance when rendered on the human readable user interface.

2. The system of claim 1, wherein the replacement text is displayed in response to a user request to view the initial text on the human readable user interface.

3. The system of claim 1, wherein the replacement text includes a set of n replacement keywords, and wherein each replacement keyword in the set of replacement keywords has a different machine encoding, and wherein the machine encoding of each of the replacement keywords is distinct from the machine encoding of the initial keyword.

4. The system of claim 1, wherein the first replacement keyword includes a zero-width element.

5. The system of claim 4, wherein the first replacement keyword includes a zero-width text string.

6. The system of claim 1, wherein the machine encoding comprises a machine generated token.

7. The system of claim 1, wherein the computing device is further configured to:
parse the initial text when prompted by a user initiated function when the human readable user interface is displaying the replacement text.

8. The system of claim 1 wherein the replacement text includes a distinct replacement keyword associated with each instance of the initial keyword.

9. The system of claim 1, wherein the computing device is further configured to:
receive a request from a computing device, the request having a request type;
transmit the replacement text to computing device based on the request type meeting replacement text criteria; and
transmit the initial text to computing device based on the request type meeting initial text criteria.

10. The system of claim 9, wherein the replacement text includes one or more homoglyphs.

11. A method comprising:
storing, in a data store, initial text including a plurality of instances of at least one an initial keyword;
identifying, for the at least one initial keyword, at least two sets of replacement characters corresponding to at least one respective character portion of the initial keyword, wherein each of the at least two sets of replacement characters have a visually similar appearance to the at least one respective character portion of the initial keyword when rendered on a display;
generating replacement text by:
for a first instance of the initial keyword in the initial text, replacing the at least one respective character portion of the initial keyword with a first set of replacement characters to generate a first replacement keyword, wherein a machine encoding of the initial keyword and a machine encoding of the first replacement keyword are distinct;
for a second instance of the initial keyword in the initial text, replacing at least one respective character portion of the initial keyword with a second set of replacement characters to generate a second replacement keyword, wherein a machine encoding of the second replacement keyword is distinct from the machine encoding of the initial keyword and the machine encoding of the first replacement keyword; and
generating instructions to display, via a human readable user interface, replacement text including the first replacement keyword and the second replacement keyword, wherein each of first replacement keyword, the second replacement keyword, and the initial keyword have a visually similar appearance when rendered on the human readable user interface.

12. The method of claim 11, wherein the replacement text is displayed in response to a user's request to view the initial text on the human readable user interface, the replacement text being visually similar to the initial text when rendered on the human readable user interface.

13. The method of claim 11, wherein each of the replacement text includes a plurality of replacement keywords, each being different from the initial keyword when parsed by a machine.

14. The method of claim 11, wherein the replacement text includes a replacement keyword including zero-width text.

15. The method of claim 11, wherein the replacement text includes a replacement keyword having a text string embedded within.

16. The method of claim 11, wherein tokenization of the replacement text generates a different series of tokens compared to tokenization of the initial text.

17. The method of claim 11 further comprising:
parsing the initial text when prompted by a search function initiated by a user interacting with the human readable user interface when the human readable user interface is displaying the replacement text.

18. The method of claim 11, wherein the replacement text includes a plurality of replacement keywords associated with each instance of the initial keyword and tokenization of the plurality of replacement keywords results in each instance of the plurality of replacement keywords having a different token.

19. The method of claim 11 further comprising:
receiving a request from a computing device, the request having a request type; and
transmitting the replacement text to computing device based on the request type meeting replacement text criteria or transmit the initial text to computing device based on the request type meeting initial text criteria.

20. A non-transitory computer readable medium having instructions stored thereon, wherein the instructions, when executed by at least one processor, cause at least one device to perform operations comprising:
storing, in a data store, initial text including a plurality of instances of at least one an initial keyword;
identifying, for the at least one initial keyword, at least two sets of replacement characters corresponding to at least one respective character portion of the initial keyword, wherein each of the at least two sets of replacement characters have a visually similar appearance to the at least one respective character portion of the initial keyword when rendered on a display;
generating replacement text by:
for a first instance of the initial keyword in the initial text, replacing the at least one respective character portion of the initial keyword with a first set of replacement characters to generate a first replacement keyword, wherein a machine encoding of the initial keyword and a machine encoding of the first replacement keyword are distinct;
for a second instance of the initial keyword in the initial text, replacing at least one respective character portion of the initial keyword with a second set of replacement characters to generate a second replacement keyword, wherein a machine encoding of the second replacement keyword is distinct from the machine encoding of the initial keyword and the machine encoding of the first replacement keyword; and
generating instructions to display, via a human readable user interface, replacement text including the first replacement keyword and the second replacement keyword, wherein each of first replacement keyword, the second replacement keyword, and the initial keyword have a visually similar appearance when rendered on the human readable user interface.

21-40. (canceled)
